(19) United States
(12) Patent Application Publication
(10) Pub. No.: US 2007/0168930 A1
(43) Pub. Date: Jul. 19, 2007

(54) System and method for designing and generating database-driven user interfaces that contain cascading plastic layout elements

(75) Inventors: Aram Mirkazemi, Lindisfarne (AU); Shahram Besharati, Kingston Beach (AU)

Correspondence Address: William C. Milks, III;RUSSO & HALE LLP, 401 Florence Street, Palo Alto, CA, 94301, US

(73) Assignee: Morfik Technology Pty. Ltd.

(21) Appl. No.: 11/603,359

(22) Filed: Nov. 20, 2006

Related U.S. Application Data
(60) Provisional application No. 60/739,176, filed on Nov. 23, 2005.

(51) Int. Cl. G06F 9/44

(52) U.S. Cl. 717/104; 717/101

(57) ABSTRACT

A system and method are disclosed for creating a user interface for database-driven web sites or software applications in which the layout of elements can accommodate and respond to expansion and contraction in a fluid-like or content-flow manner at run-time, but is also constrained by fixed or grid-like sizes, positions, and properties that are specified at design-time. This aspect of controlling the layout of controls via a hybrid of fixed as well as fluid properties, all of which an be visually or programmatically specified at design-time as well as at run-time, provides significant advantages over previous web site and software application design tools and techniques.

### CROSS-REFERENCE TO RELATED APPLICATION

This application relates to U.S. Provisional Patent Application No. 60/739,176 filed on Nov. 23, 2005 entitled SYSTEM AND METHOD FOR DESIGNING AND GENERATING DATABASE-DRIVEN USER INTERFACES THAT CONTAIN CASCADING PLASTIC LAYOUT ELEMENTS.

### BACKGROUND OF THE INVENTION

1. Field of the Invention

The present invention relates generally to a system and method for computer programming of web sites and software applications and, more particularly, to a system and method to enable a web site developer or application programmer to program user interfaces for web sites and software applications characterized in that the interfaces have a flexible layout. In accordance with various embodiments of the present invention, a system and method provide a software development tool that allows a web site developer or application programmer to specify, at design-time, the layout of elements or components using a fixed layout scheme and paradigm, whilst also allowing him or her to define the level of fluidity that will occur at run-time.

2. Description of the Prior Art

By way of background, conventional layout techniques for user interfaces include either a fixed layout approach or a fluid layout approach. These approaches are as follows.

Fixed layout, often known as absolute or grid layout, is when the web site developer or application programmer specifies the precise location and size of each element or component of a user interface in absolute terms, for example, defining the layout by specifying the exact distance each control is from the top edge and left-hand edge of the user interface. The benefits of the fixed layout approach are often best seen when designing user interfaces that have high levels of functionality. Web site developers and application programmers must ensure that controls with particular functions are located in very well-defined positions, independent of the amount of content displayed. This fixed layout approach does not require the components of the user interface to have any built-in or natural order. That is, the logical location and position of each control is independently defined. Consequently, if a component, through some mechanism and for whatever reason, is resized or repositioned, then the neighboring controls will not be adjusted. Although in many cases this is advantageous, at times resizing or repositioning results in overlapping of controls, an effect that in some cases is clearly undesirable for both the web site developer or application programmer and the user.

The alternative to fixed layout is a fluid or content-flow layout approach. In this case, the web site developer or application programmer does not specify the exact position or size of the text-based controls, but rather allows the application (e.g., web browser, word processor, etc.) to determine the most appropriate position and size for the control based on predefined content-flow standards and expectations. For example, ensuring that the content flows in a left-to-right and top-to-bottom manner constitutes content-flow layout. Using the content-flow layout paradigm, the components are dynamically adjusted according to the amount of content that they contain, and therefore the positions of many surrounding controls are also automatically adjusted to accommodate this resizing. This approach to resizing is often referred to as “liquid layout,” as it quickly, easily, and automatically reshapes itself to fit the given container and conditions. Intrinsic in this approach is the assumption that there is a natural and sequential order within the content. This logical order between all of the components is maintained irrespective of the size and position of each individual component. The content-flow layout approach is standard practice where content or information is central, for example, in word processing applications. The disadvantage of the content-flow layout approach arises if the web site developer or application programmer requires a control, such as a control for navigating, to remain in a fixed position, independent of the content displayed. In such a case, the content-flow layout approach will not allow the web site developer or application programmer to achieve the desired result.

Software development tools generally offer web site developers and application programmers a choice of either fixed layout design capabilities or fluid layout design capabilities, with only a few that offer a combination of the two. However, even these more advanced development tools are significantly limited. That is, whichever layout approach the web site developer or application programmer chooses for a component at design-time cannot be changed at run-time. If the occasion arises when the web site developer or application programmer has to change the run-time characteristics of a component, he or she would need to write code at a very low level of abstraction, much lower than that in which the remainder of the application was written. This is because known development tools do not allow web site developers or application programmers to alter the behavior of a control at run-time using effectively the same development methodology and at the same level of abstraction that he or she used at design-time.

In summary, the known use of either a fixed layout approach or a fluid layout approach has significant disadvantages, and the known use of development tools having both fixed and fluid layout design capabilities has significant limitations. What is needed is a system and method that provide the advantages of both fixed and fluid layouts allowing components to be specified at design-time with the level of fluidity that will occur at run-time. The various embodiments of the system and method in accordance with the present invention provide many advantages over conventional web site and software application programming approaches.

### SUMMARY OF THE INVENTION

In accordance with the various embodiments of the present invention, a system and method are provided for creating user interfaces for database-driven web sites or software applications where the layout of elements or components can accommodate and respond to expansion and contraction in a fluid-like or content-flow manner at run-time, but is also constrained by fixed or grid-like sizes, positions, and properties that are specified at design-time. This aspect of controlling the layout of elements via a hybrid of fixed as well as fluid properties, all of which can be specified either visually or programmatically at design-time, as well as at run-time, provides significant advantages over previous web site and software application design tools and methodologies.

The system and method in accordance with various embodiments of the present invention provide user interface layout design which offers the strengths of both a fixed layout approach and a fluid layout approach. Combining the best of fixed layouts and fluid layouts in accordance with the principles of the present invention, both at design-time as well as at run-time, is referred to as “plastic layout.” Using plastic layout, the content of the web site or software application is a hierarchy of heterogeneous nodes. Each node is aware of the existence, state, and behavior of other nodes and can respond to layout changes at run-time according to the rules specified by the web site developer or application programmer at design-time. In other words, at design-time, the web site developer or application programmer can define both the fixed position of each element, as well as its run-time plasticity. This uniquely incorporates the best of both fluid and fixed layout design approaches.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 shows the Project Manager for the Visual Programming Environment used to create the plastic layout in accordance with the various embodiments of the system and method of the present invention for controlling the layout of elements of a user interface via a hybrid of fixed as well as fluid properties;

FIG. 2 illustrates a form containing a subform at design-time;

FIG. 3 illustrates a form containing a control with plastic behavior;

FIG. 4 illustrates a first example of a plastic layout in accordance with an embodiment of the system and method of the present invention;

FIG. 5 illustrates a second example of a plastic layout in accordance with an embodiment of the system and method of the present invention;

FIG. 6 illustrates a third example of a plastic layout in accordance with an embodiment of the system and method of the present invention;

FIG. 7 illustrates a fourth example of a plastic layout in accordance with an embodiment of the system and method of the present invention; and

FIG. 8 illustrates a fifth example of a plastic layout in accordance with an embodiment of the system and method of the present invention.

### DETAILED DESCRIPTION OF THE PREFERRED EMBODIMENTS

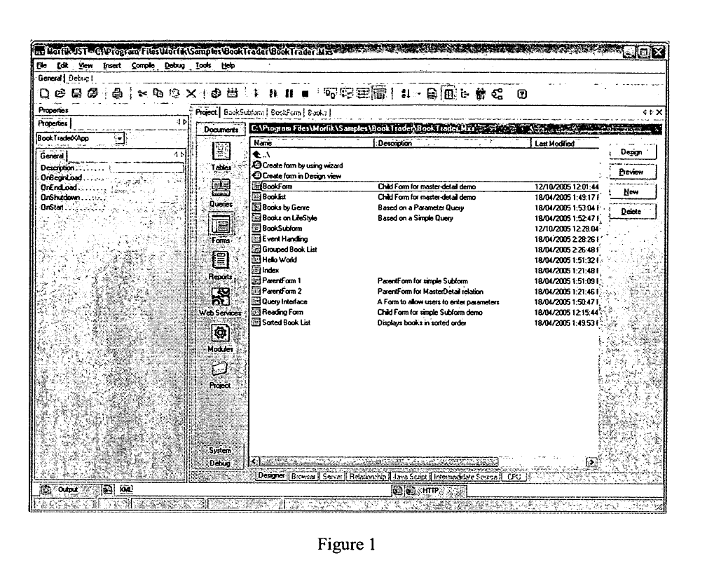

The present invention is particularly applicable to a computer-implemented software-based system and method to code web sites and software applications having a user interface that consists of a hybrid of fixed as well as fluid properties, all of which can be specified at design-time (visually or programmatically) as well as at run-time, and it is in this context that the various embodiments of the present invention will be described. The examples included are based on a preferred embodiment which includes a Visual Programming Environment, as shown in FIG. 1. FIG. 1 shows the Project Manager for the Visual Programming Environment used to create the plastic layout in accordance with the various embodiments of the system and method of the present invention for controlling the layout of elements via a hybrid of fixed as well as fluid properties.

Considered in more detail, the design process will now be described. The system and method in accordance with the various embodiments of the present invention enable a developer to use a visual design environment to create dynamic data-driven web sites or software applications that are dynamically responsive based on content. For the purpose of describing the nature of plastic layouts in accordance with the system and method of the present invention, reference will be made to three types of controls that are implemented in the system and method in accordance with the various embodiments of the present invention. The implementation of a plastic layout in accordance with the principles of the present invention includes, but is not necessarily limited to, these three types of controls.

The first type of control comprises simple, fixed-size controls. For these controls, even if they are data-bound, their height and width remains unchanged, irrespective of the data being displayed. An example of one of these controls is a DateTimeEdit control which appears as a rectangle with date and/or time information displayed inside the rectangle. For comparative purposes, there is a similar control, by the same name, in Microsoft Access.

The second type of control comprises simple, variable-sized controls which can adapt in size according to the data that is to be displayed. An example of one of these controls is a TextLabel that defines a rectangular region wherein static or data-bound text can be displayed. For comparative purposes in Microsoft Access, the textedit control is of this type.

The third type of control comprises “containing” controls. Multiple simple controls may be placed directly or indirectly into the region specified by such containing controls. Repositioning these containing controls automatically repositions all controls that are contained within the region. Note that these containing controls can be nested; that is, a containing control may be placed inside another containing control. Two examples of one of these controls are Containers and subforms. For comparative purposes, in Microsoft Access, panels and subforms are of this type. Note that in the case of subforms, the controls are indirectly placed in the region, as the subform simply specifies the location where another form (and all of its controls) will appear.

These three examples of controls, namely, DateTimeEdit controls, TextLabels, and Containers, fully illustrate the nature of fixed-size, variable-size, and containing controls, respectively. For the sake of brevity, these controls will be referred to as “archetypal controls.”

TextLabels and Containers are special controls that can grow or shrink based on the amount of content within them. Each of these controls preferably has four fully-independent properties that can be set at design-time but are implemented at run-time.

These properties comprise:
(i) their size (height and width);
(ii) their positions (defined absolutely in terms of the distance to the top left-hand corner of the containing control);
(iii) whether they can grow larger (in height) than the size set at design time; and
(iv) whether they can shrink (in height) from the size set at design time.
   It is also important to note that the height of a control may change not only due to the amount of content it displays, but also based on the dimensions of the user interface. This is especially important in web sites, because the overall dimensions of the user interface are defined by the user via the dimensions of the browser window. In many applications which are designed using only a fixed layout approach, if the width of the user interface (e.g., browser window) is reduced too much, then part of the user interface becomes no longer visible. In applications that are designed using a liquid layout, when the width of the user interface is reduced, the content is dynamically resized and repositioned. For example, in word processors, reducing the width of the window decreases the length of each line, but the automatic word-wrap feature ensures that the content is repositioned so that no information extends beyond the left- or right-hand edges of the window. However, such an approach has the disadvantage that controls which should remain in a fixed position, such as navigation controls, will also move around the screen based on the dimensions of the window.

In accordance with the various embodiments of the system and method of the present invention, the developer can specify and control the level of plasticity for each element, both at design-time as well as run-time, not only when its content changes, but also when the width of the user interface changes. The system and method of the present invention therefore relieve the web site developer or application programmer from being constrained by having to choose at design-time whether the controls are to be permanently based either on a fixed or on a fluid layout, but rather give him or her the flexibility of both approaches at all times.

The run-time process will now be described in detail. In accordance with the various embodiments of the system and method of the present invention, the feature of growing and shrinking is accompanied by a complementary and intrinsic system and method that allows controls to be dynamically and automatically repositioned at run-time. Every time a certain control automatically shrinks or grows, the system and method of the present invention automatically reposition all controls that lie directly below the certain control and reposition them by the amount that the certain control shrank or grew. This ensures that the relative positioning between controls remains unchanged. This complementary system and method are the key to providing the fluid characteristics of the layout process.

Note also that the growing and shrinking in accordance with the various embodiments of the system and method of the present invention do not affect the position of controls that are located vertically above. Controls that are located to the left or right of an expanding control are only repositioned vertically. The horizontal positions remain unchanged.

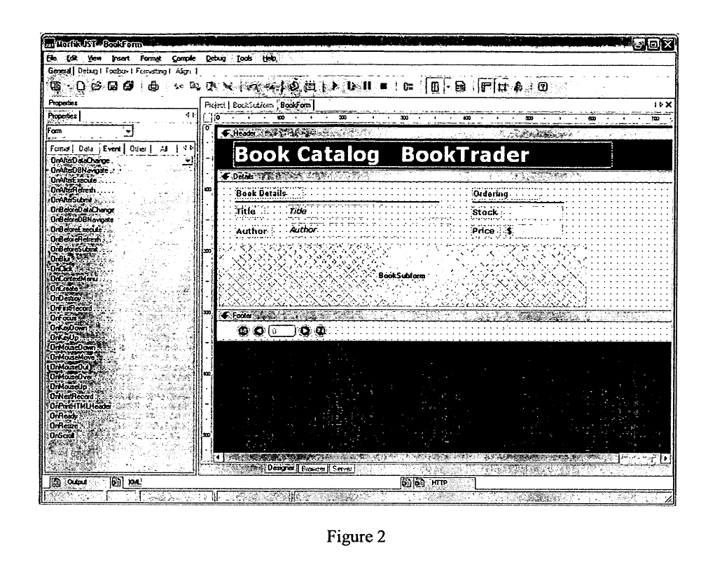

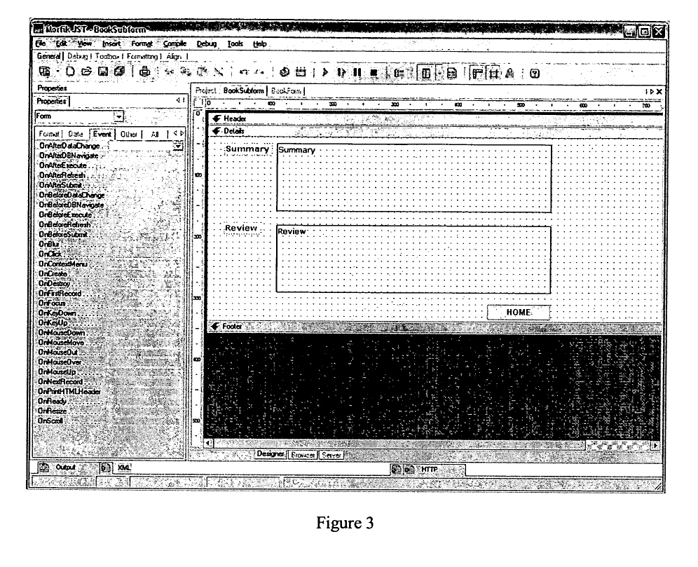

Furthermore, in accordance with the various embodiments of the system and method of the present invention, the twin features of dynamic resizing and dynamic repositioning are cascading in nature, as shown in FIGS. 2-8. FIG. 2 illustrates a form containing a subform at design-time. This simple form contains two text labels and a subform that is connected to another form, namely, “Book Form.” FIG. 3 illustrates a form containing a control with plastic behavior. “TextLabel4” is connected to a datafield “Review” which is a field of “Booklist Table.” Using the Property Sheet, the web site developer can alter the CanGrow and CanShrink properties independently of this TextLable. If a TextLabel or Container grows so large that its lower edge extends beyond its bounding parent object which may be another Container, then the parent Container can also automatically increase its height so that the TextLabel is fully contained within it. For example, the size of the subform in FIG. 2 is dynamically increased in order to contain the form, as shown in FIG. 3. That is, growing and shrinking has a cascading effect.

Moreover, repositioning can also have a cascading effect. Since Containers can be nested to arbitrary levels, the cascading effects can also be applied to arbitrary levels. However, the web site developer or application programmer can fully control the degree of this cascading effect. Simply setting a Container's “CanGrow” and “CanShrink” properties to “False” at design-time (or at run-time) prevents the cascading effect. In this case, if a TextLabel that is located in the Container were to grow too large, then some of it may not be visible to the user due to the Container not growing.

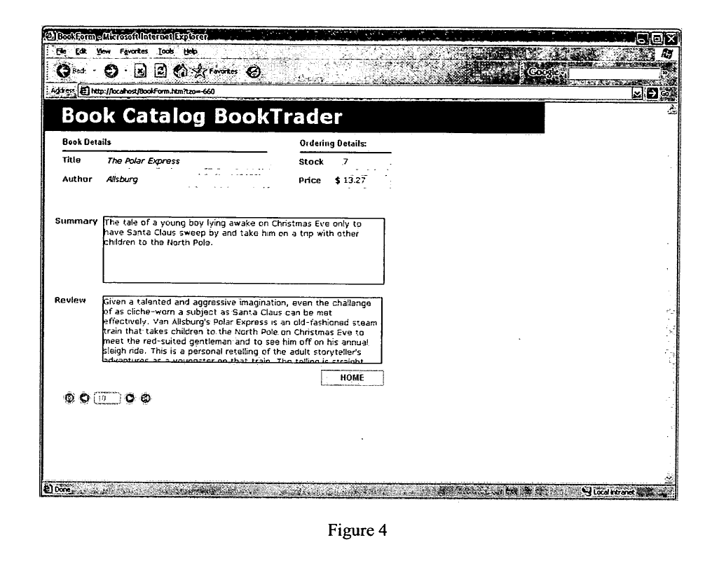

FIG. 4 illustrates a first example of a plastic layout in accordance with an embodiment of the system and method of the present invention. FIG. 4 shows the form illustrated in FIG. 2, but at run-time. Note that the height of the Form “BookSubForm” at run-time is larger than it was defined at design-time, as shown in FIG. 2. This is an example of the cascading nature of the grow feature.

In the example shown in FIG. 4, the CanShrink and CanGrow properties of the TextLabel (for the summary and review section) have been set to “False.” This example typifies absolute positioning and sizing. There are a few disadvantages to this mode. Sometimes the text areas are too small for the dynamic content (e.g., the Review TextLabel). Since the font size of the text is often variable, having a fixed height also often leads to lines of text being only partially visible (e.g., Review TextLabel). Also, sometimes the TextLabels are too large and result in unnecessary blank areas (e.g., Summary TextLabel).

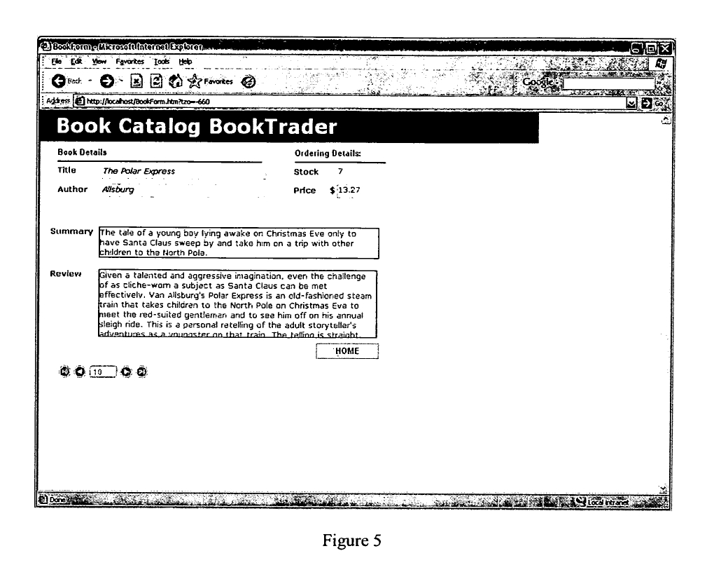

FIG. 5 illustrates a second example of a plastic layout in accordance with an embodiment of the system and method of the present invention. In the example shown in FIG. 5, the property “CanShrink” associated with the Summary and Review TextLabels is set to “True.” In this case, if a TextLabel is linked to only a small amount of content, then the system and method of the present invention will automatically and dynamically reduce its height and therefore eliminate much of the unwanted blank area (e.g., Summary TextLabel). Note that this property has no effect on TextLabels which contain a significant amount of content (e.g., Review TextLabel). Further, note that the distance between the controls below the bottom of the review text area have been dynamically repositioned, which maintains a consistent and coherent layout of the user interface.

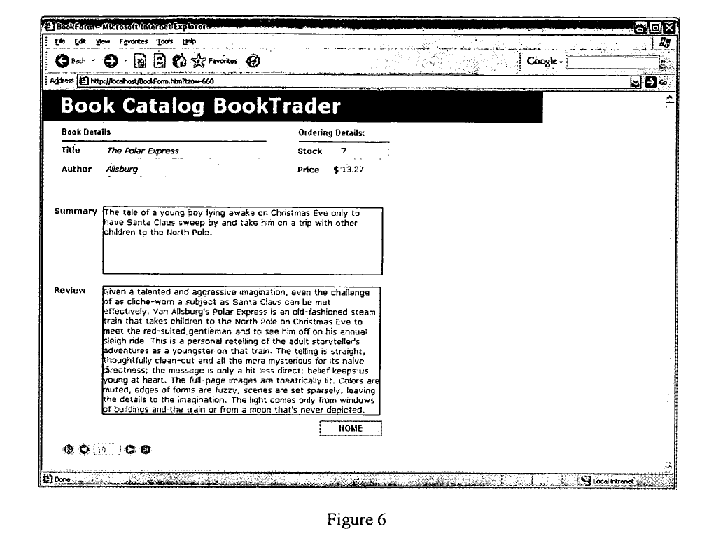

FIG. 6 illustrates a third example of a plastic layout in accordance with an embodiment of the system and method of the present invention. In the example shown in FIG. 6, the property “CanGrow” associated with the TextLabels is set to “True.” In this case, if the text area is linked to a large amount of content, then the text area will increase in height and therefore display all of the data-driven content (e.g., Review TextLabel). Note that this property has no effect on the height of TextLabels which do not contain much content (e.g., Summary TextLabel).

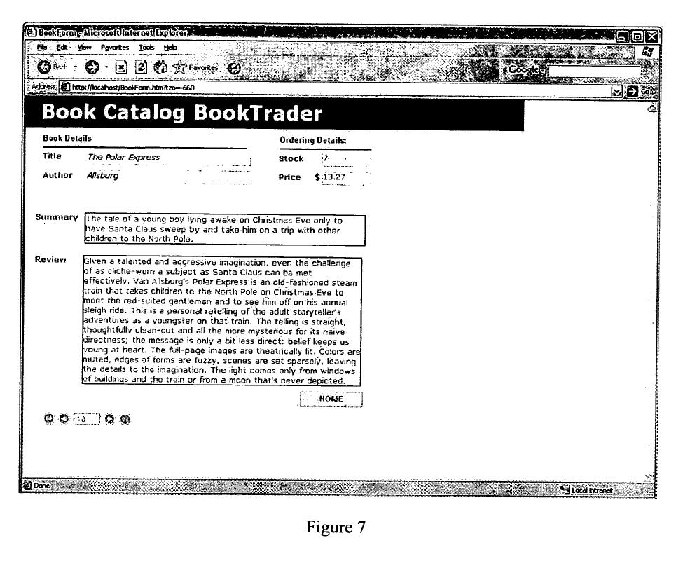

FIG. 7 illustrates a fourth example of a plastic layout in accordance with an embodiment of the system and method of the present invention. In the example shown in FIG. 7, the properties “CanGrow” and “CanShrink” associated with the TextLabels are both set to “True.” Note in this case, if the text area is linked to a large amount of content, then the text area will increase in height and therefore display all of the data-driven content (e.g., Review TextLabel). Furthermore, if the text area is linked to only a small amount of content, then the text area will reduce in height and therefore eliminate much of the unwanted blank area (e.g., Summary TextLabel).

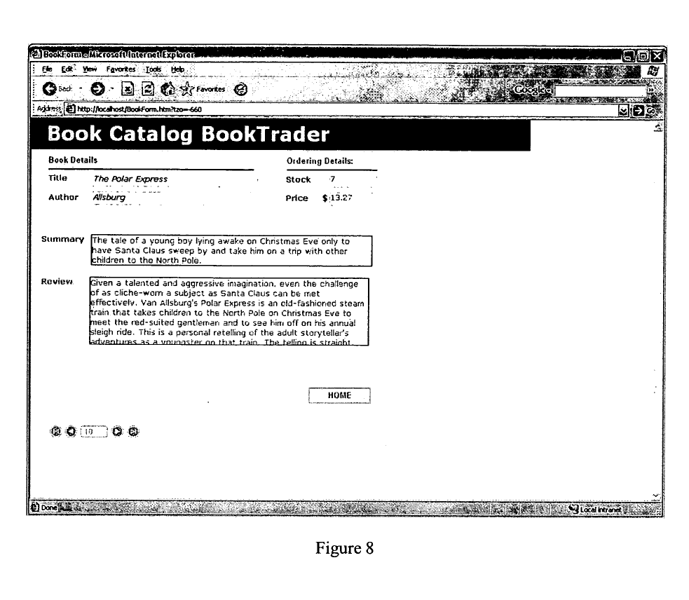

FIG. 8 illustrates a fifth example of a plastic layout in accordance with an embodiment of the system and method of the present invention. In the example shown in FIG. 8, the property “CanShrink” associated with the Summary and Review TextLabels is set to “True.” However, the “Home” button at the bottom of the form has been set to not move.

This aspect of controlling the size and layout of repeating controls and bands via a hybrid combination of static and dynamic resizing and repositioning of controls, of which all can be specified at either design-time (visually or programmatically) or at run-time, provides a significant advantage over previous web site and software application design tools and techniques. The programmatic functionality and extensibility of the various embodiments of the system and method in accordance with the present invention will now be described.

In accordance with the various embodiments of the present invention, all of the following properties can be dynamically altered at run-time without requiring expertise in JavaScript or programming:
(i) the height and/or width of any control;
(ii) the absolute positioning of controls (relative to the top left-hand corner of the parent containing control);
(iii) the CanGrow and/or the CanShrink properties of variable-sized or containing controls; and
(iv) the option to override the cascading repositioning of controls to ensure a control's position remains unchanged irrespective of the resizing or repositioning of its child sibling controls.

The following examples of code for each of these four scenarios will now be described in order to illustrate that the web site developer or application programmer can maintain a high level of abstraction when achieving this overriding behavior. For each of the first three scenarios (i.e., (i)-(iii), above), the code required is a straightforward one-line command that can be inserted almost anywhere in the application logic.

| | |
|---|---|
| (i) | |
| TextLabel1.Height := | 10; |
| (ii) | |
| DateTimeEdit1. Top := | 100; |
| (iii) | |
| Container1.CanShrink := | False; |

As previously mentioned, by invoking this third option on Containers, the web site developer or application programmer can easily define and limit the cascading nature of the dynamic growing and shrinking.

For option (iv), above, the web site developer or application programmer needs to associate the control with the OnBeforePushedOrPulled event as follows:

Function “Product Editor
Form”.DateTimeEdit1BeforePushedOrPulled(Var deltaY:
Integer);
Begin
deltaY :=0;
End;

In this case, the system and method automatically create all the necessary code, except the line:

deltaY:=0;

By invoking this fourth option on Containers, the web site developer or application programmer can easily define and limit the cascading nature of dynamic repositioning.

While the foregoing description has been with reference to particular embodiments of the present invention, it will be appreciated by those skilled in the art that changes to these embodiments may be made without departing from the principles and spirit of the invention. Accordingly, the scope of the present invention can only be ascertained with reference to the appended claims.

What is claimed is:

1. A method for creating user interfaces for database-driven web sites or software applications wherein the layout of elements can accommodate and respond to expansion and contraction in a fluid-like or content-flow manner at run-time, but is also constrained by fixed or grid-like sizes, positions, and properties that are specified at design-time, by controlling the layout of elements via a hybrid of fixed as well as fluid properties, all of which are specified either visually or programmatically at design-time, as well as at run-time, thereby providing a plastic layout.

2. The method of clam 1 wherein the plastic layout consists of a hierarchy of heterogeneous nodes in which each node is aware of the existence, state, and behavior of other nodes and can respond to layout changes at run-time according to rules specified at design-time, so that at design-time both the fixed position of each element, as well as its run-time plasticity, are defined.

3. The method of claim 1 wherein the level of plasticity for each element, both at design-time as well as run-time, is specified not only when its content changes, but also when the width of the user interface changes.

4. The method of claim 1 wherein the plastic layout is specified by three types of controls consisting of DateTimeEdit controls, TextLabels, and Containers that fully illustrate the nature of fixed-size, variable-size, and containing controls, respectively.

5. The method of claim 4 wherein controls that are located to the left or right of an expanding control are only repositioned vertically and the horizontal positions remain unchanged.

6. The method of claim 4 wherein every time a certain control automatically shrinks or grows, all controls that lie directly below the certain control are automatically repositioned by the amount that the certain control shrank or grew.

7. The method of claim 1 wherein dynamic resizing and dynamic repositioning are cascading in nature.

8. A system for creating user interfaces for database-driven web sites or software applications wherein the layout of elements can accommodate and respond to expansion and contraction in a fluid-like or content-flow manner at run-time, but is also constrained by fixed or grid-like sizes, positions, and properties that are specified at design-time, comprising means for controlling the layout of elements via a hybrid of fixed as well as fluid properties, all of which are specified either visually or programmatically at design-time, as well as at run-time, whereby a plastic layout is provided.

9. The system of claim 8 wherein the plastic layout consists of a hierarchy of heterogeneous nodes in which each node is aware of the existence, state, and behavior of other nodes and can respond to layout changes at run-time according to rules specified at design-time, so that at design-time both the fixed position of each element, as well as its run-time plasticity, are defined.

10. The system of claim 8 wherein the level of plasticity for each element, both at design-time as well as run-time, is specified not only when its content changes, but also when the width of the user interface changes.

11. The system of claim 8 wherein the plastic layout is specified by three types of controls consisting of DateTimeEdit controls, TextLabels, and Containers that fully illustrate the nature of fixed-size, variable-size, and containing controls, respectively.

12. The system of claim 11 wherein controls that are located to the left or right of an expanding control are only repositioned vertically and the horizontal positions remain unchanged.

13. The system of claim 11 wherein every time a certain control automatically shrinks or grows, all controls that lie directly below the certain control are automatically repositioned by the amount that the certain control shrank or grew.

14. The system of claim 8 wherein dynamic resizing and dynamic repositioning are cascading in nature.
